(19) United States
(12) Patent Application Publication
(10) Pub. No.: US 2025/0345976 A1
(43) Pub. Date: Nov. 13, 2025

(54) INJECTION MOLDING MOLD

(71) Applicant: KABUSHIKIGAISHA KATAZEN, Obu-shi (JP)

(72) Inventor: Yuichi KONDO, Aichi (JP)

(21) Appl. No.: 19/189,643

(22) Filed: Apr. 25, 2025

(30) Foreign Application Priority Data
May 7, 2024 (JP) 2024-75064

(51) Int. Cl. B29C 45/34; B29C 45/32; B29C 45/37

(52) U.S. Cl. CPC B29C 45/34; B29C 45/32; B29C 45/37; B29C 2045/378

(57) ABSTRACT

An injection molding mold includes a columnar core mold and a pair of split molds disposed so as to surround the entire periphery of the core mold. The injection molding mold effectively degassing the inside of a cavity for molding an irregular tubular molded article opened at one end and closed at the other end. A piece plate stack (J), configured such that a plurality of degassing piece plates P₁ to P₄ is stacked on each other, is integrally incorporated into a portion of each of a pair of split molds (B₁, B₂) forming a box-shaped second cavity of a cavity, and degassing grooves G₁ to G₄ formed in each of the degassing piece plates P₁ to P₄ are covered with another degassing piece plate P₂ to P₄ located immediately thereabove. Gas accumulated in the cavity is discharged to the outside of the molding mold through degassing holes H.

### 1. TECHNICAL FIELD

The present invention relates to an injecting molding mold including a columnar core mold and a pair of split molds disposed so as to surround the entire periphery of the core mold and formed with a cavity for molding an irregular tubular molded article opened at one end and closed at the other end on a molten resin injection side.

### 2. BACKGROUND ART

By injecting molten thermoplastic elastomer (molten resin) into a cavity formed between a columnar core mold and a plurality of outer molds disposed so as to surround the core mold, an irregular tubular molded article can be molded, which is opened only at one end portion in a removal direction and provided at such an opened portion with a great-dimension portion having a greater dimension than that of a portion molded with the core mold. The molten resin is injected from the cavity side for molding the closed portion of the irregular tubular molded article opposite to the great-dimension portion, and the cavity for molding the box-shaped great-dimension portion is the farthest from the cavity for molding the closed portion of the molded article, and is bent from the cavity for molding a cylindrical portion. Thus, gas in the cavity tends to be accumulated in the cavity for forming the great-dimension portion. As a result, a sink mark, underfill due to lack of the molten resin, and the like are caused at the great-dimension portion of the irregular tubular molded article, which leads to a molding defect.

Corresponding to the molded article shape, a portion of the core mold for molding the box-shaped great-dimension portion on the molded article opening side is formed in a block shape, and the applicant of this patent application has attempted to embed a plurality of vents formed with micro discharge holes in the block-shaped portion of the core mold to form vent formation marks not in the outer surface of the molded article but in portions of the inner surface where the vents are present, thereby preventing deterioration of the appearance of the molded article and discharging gas from the portion of the cavity for forming the great-dimension portion. In this gas discharge method, gas in the portion where each vent is present can be effectively discharged, but gas is accumulated in another portion of the cavity where no vent is present, which causes a sink mark, underfill, and the like at the outer surface of the molded article. For this reason, this method has not been in practical use.

Generally, as described in Patent Literature 1, in a case where for resin injection molding, a cavity is provided in each mold contact surface of split molds, extremely-thin shims are disposed on each mold contact surface so that gas in the cavity can be discharged. However, in a case where the cavity is formed between the core mold and the pair of split molds disposed so as to surround the entire periphery of the core mold, a gas discharge hole needs to be provided inside the core mold or the pair of split molds forming the molding mold in order to discharge gas from the portion of the cavity corresponding to the great-dimension portion of the irregular tubular molded article having such a great-dimension portion on the opening side as described above. For this reason, it is difficult to discharge such gas.

### CITATION LIST

### Patent Literature

[PTL 1] JP2017-213692A

### SUMMARY OF THE INVENTION

### 1. Technical Problem

The present invention is intended to provide an injecting molding mold including a columnar core mold and a pair of split molds disposed so as to surround the entire periphery of the core mold, the injection molding mold effectively degassing the inside of a cavity for molding an irregular tubular molded article opened at one end and closed at the other end on a molten resin injection side.

### 2. Solution to the Problem

In order to solve the above-described problem, a first aspect of the invention is an injection molding mold including a columnar core mold and a pair of split molds disposed so as to surround the core mold to form a cavity, in which molten resin is injected into the cavity to mold an irregular tubular molded article opened only at one end portion in a removal direction, closed at the other end portion on a molten resin injection side, and at the opened portion, provided with a quadrangular box-shaped great-dimension portion having a greater dimension than those of other portions, and thereafter, the split molds are separated from the core mold and the molded article is removed from the core mold.

A piece plate stack configured such that a plurality of flat plate-shaped degassing piece plates, each of which is formed with a degassing groove at least in one surface, is stacked and integrated along the molded article removal direction is incorporated into a piece plate stack arrangement recess provided in a portion of each split mold for molding the great-dimension portion, and the degassing grooves form, in the portion of each split mold for molding the great-dimension portion of the molded article, many degassing holes causing a portion of the cavity for molding the great-dimension portion and the outside of the molding mold to communicate with each other, and

each degassing groove forming the degassing holes is formed with such a depth that entrance of the molten resin injected into the cavity into the degassing holes is able to be reduced.

According to the first aspect of the invention, the piece plate stack configured such that the plurality of flat plate-shaped degassing piece plates, each of which is formed with the degassing groove at least in one surface, is stacked along the molded article removal direction is incorporated into the piece plate stack arrangement recess provided in the portion of each split mold for molding the quadrangular box-shaped great-dimension portion of the molded article, and inside the piece plate stack, the plurality of degassing holes causing the portion of the cavity for molding the great-dimension portion and the outside of the molding mold to communicate with each other is formed. Thus, the plurality of degassing holes can be directly formed in the portions of the pair of split molds for forming the great-dimension portion. In addition, since each degassing groove forming the degassing holes is formed with such a depth that the entrance of the molten resin injected into the cavity into the degassing holes can be reduced, gas easily accumulated in the portion of the cavity for molding the great-dimension portion can be effectively discharged from each degassing hole to the outside of the molding mold. Thus, the great-dimension portion where a sink mark, underfill, and the like are easily caused in conventional molding can be molded as designed with no such a sink mark, underfill, and the like.

Moreover, according to the first aspect of the invention, each degassing groove forming many degassing holes formed inside the piece plate stack needs to be formed with such a depth that the entrance of the molten resin injected into the cavity into the degassing holes can be reduced. However, there is no limitation on the width of the degassing groove, and therefore, the degassing groove is formed wide so that the cross-sectional area of the degassing hole can be increased and the total cross-sectional area of many degassing holes can be significantly increased. On this point, gas accumulated in the portion of the cavity corresponding to the great-dimension portion can be reliably effectively discharged to the outside of the molding mold.

A second aspect of the invention is the injection molding mold according to the first aspect of the invention, in which the depth of the degassing groove is 0.02 to 0.03 mm.

In the second aspect of the invention, the depth of the degassing groove formed in the surface of the degassing piece plate is specified as 0.02 to 0.03 mm as such a limit that the resin can enter the degassing hole. The groove with this depth can be formed by grinding of a metal plate.

A third aspect of the invention is the injection molding mold according to the first or second aspect of the invention, in which among the plurality of degassing piece plates, a degassing piece plate disposed on the outermost side has the greatest plate thickness, and a middle degassing piece plate has a smaller plate thickness than that of a degassing piece plate disposed on each side of the middle degassing piece plate in a stacking direction, and the piece plate stack incorporated into the piece plate stack arrangement recess of each split mold is fixed to the each split mold with a plurality of fixing bolts.

According to the third aspect of the invention, a recess in which a head portion of the fixing bolt is inserted and disposed can be provided in the degassing piece plate disposed on the outermost side and having the greatest plate thickness, and therefore, the fixing bolt does not protrude from the piece plate stack incorporated into the piece plate stack arrangement recess of each split mold and each split mold as a movable mold is easily designed.

A fourth aspect of the invention is the injection molding mold according to the first or second aspect of the invention, in which a gas discharge gap through which gas is discharged to the outside of the molding mold through many degassing holes formed inside the piece plate stack is formed between the outer surface, which is opposite to the cavity, of the piece plate stack incorporated into the piece plate stack arrangement recess and the inner surface of the piece plate stack arrangement recess.

According to the fourth aspect of the invention, gas discharged through many degassing holes formed inside the piece plate stack can be effectively discharged to the outside of the molding mold through the gas discharge gap.

A fifth aspect of the invention is the injection molding mold according to the first or second aspect of the invention, in which the injection molding mold has a configuration capable of simultaneously molding two molded articles, and cavities for molding the molded articles communicate with each other through another degassing hole formed inside the piece plate stack.

According to the fifth aspect of the invention, in the injection molding mold capable of simultaneously forming the two molded articles, portions of the cavities for molding great-dimension portions communicate with each other through the another degassing hole formed inside the piece plate stack, and therefore, in a case where there is a pressure difference between the two cavities due to a difference in the total amount of accumulated gas or the like, gas moves from one cavity to the other cavity such that a gas accumulation state is equalized between the cavities. Thus, the gas in each cavity can be effectively discharged.

A sixth aspect of the invention is an injection molding mold including a columnar core mold and a pair of split molds disposed so as to surround the core mold to form a cavity, in which molten resin is injected into the cavity to mold an irregular tubular molded article opened only at one end portion in a removal direction and closed at the other end portion on a molten resin injection side, and thereafter, the split molds are separated from the core mold and the molded article is removed from the core mold.

A piece plate stack configured such that a plurality of flat plate-shaped degassing piece plates, each of which is formed with a degassing groove at least in one surface, is stacked and integrated along the molded article removal direction is incorporated into a piece plate stack arrangement recess provided in a portion of each split mold for molding the opening side of the molded article, and the degassing grooves form, in the portion of each split mold for molding the opening side of the molded article, many degassing holes causing a portion of the cavity for molding the opening side of the molded article and the outside of the molding mold to communicate with each other, and

each degassing groove forming the degassing holes is formed with such a depth that entrance of the molten resin injected into the cavity into the degassing holes is able to be reduced.

The molded article according to the first aspect of the invention is in the irregular tubular shape opened only at one end portion in the removal direction, closed at the other end portion on the molten resin injection side, and at the opened portion, provided with the great-dimension portion having the greater dimension than those of the other portions, and on the other hand, the molded article according to the sixth aspect of the invention is in the irregular tubular shape opened only at one end portion in the removal direction and closed at the other end portion on the molten resin injection side and has no great-dimension portion. Even in a case where no great-dimension portion is provided on the opening side of the molding mold, the molten resin is injected from the closed side of the molded article, and therefore, the molten resin reaches last the opening side of the molded article and gas is easily accumulated on such a side. Thus, the piece plate stack configured such that the plurality of flat plate-shaped degassing piece plates, each of which is formed with the degassing groove at least in one surface, is stacked and integrated along the molded article removal direction is incorporated into the piece plate stack arrangement recess provided in the portion of each split mold for molding the opening side of the molded article, and therefore, the degassing grooves form, in the portion of each split mold for molding the opening side, many degassing holes causing the portion of the cavity for molding the opening side and the outside of the molding mold to communicate with each other. This can reduce a sink mark, underfill, and the like, and allows the molding of the molded article.

### 3. Advantageous Effects of the Invention

According to the present invention, the piece plate stack configured such that the plurality of flat plate-shaped degassing piece plates, each of which is formed with the degassing groove at least in one surface, is stacked along the molded article removal direction is integrally incorporated into the piece plate stack arrangement recess provided in the portion of each split mold for molding the opening side of the molded article, and therefore, many degassing holes causing the portion of the cavity for molding the opening side of the molded article and the outside of the molding mold to communicate with each other can be directly formed in the portions of the pair of split molds for forming the great-dimension portion. As a result, gas easily accumulated in the portion of the cavity for molding the opening side of the molded article can be effectively discharged from many degassing holes to the outside of the molding mold. Thus, the molded article can be molded by reducing or preventing a sink mark, underfill, and the like at the opened portion of the molded article.

Particularly, in a case where the great-dimension portion having the greater dimension than those of the other portions is provided on the opening side of the formed article, the path of the cavity is bent, the molten resin injected from the closed side of the molded article is less likely to reach one side, and gas is easily accumulated in the portion of the cavity for molding the great-dimension portion of the molded article. Thus, the effects of the present invention are significantly exhibited.

### BRIEF DESCRIPTION OF THE DRAWINGS

FIG. 1 is a front view (view in the direction of an arrow indicated by U-U line of FIG. 6 in a state of a pair of split molds B₁, B₂ being closed) of a movable mold M of an injection molding mold K.

FIG. 2 is a plan sectional view (sectional view taken along X-X line of FIG. 1) in a state of the pair of split molds B₁, B₂ being closed and a cavity C being formed between the pair of split molds B₁, B₂ and core molds A.

FIG. 3(a) is an enlarged view of a main portion of FIG. 2, and FIG. 3(b) is an enlarged sectional view taken along Z-Z line of FIG. 3(a).

FIG. 4 is a sectional view taken along Y-Y line of FIG. 2.

FIG. 5 is an enlarged view of a main portion of FIG. 4.

FIG. 6 is a plan sectional view of the injection molding mold K when compressed air is supplied between the inner peripheral surface of a molded article F and the outer peripheral surface of the core mold A to slightly expand the molded article F and protrude an ejector pin E to remove the molded article F from the core mold A.

FIG. 7 is a partially-broken perspective view of the molded article F.

FIG. 8 is a perspective view of the split mold B₁ (B₂) into a piece plate stack arrangement recess 9 of which a piece plate stack J is incorporated.

FIG. 9 is an exploded perspective view of one split mold B₁ (B₂), a pair of core molds A, and the piece plate stack J.

FIGS. 10(a) and 10(b) are an exploded perspective view of a plurality of degassing piece plates P₁ to P₄ forming the piece plate stack J and a perspective view of the piece plate stack J, and FIG. 10(c) is a partially-enlarged sectional view of the degassing piece plates P₁ to P₄.

FIG. 11 is a perspective view showing one split mold B₁ (B₂) diagonally from below.

FIG. 12 is a longitudinal sectional view of a degassing groove G₄ of the piece plate stack J integrally incorporated into the piece plate stack arrangement recess 9 of each split mold B₁, B₂, which shows a state of many degassing holes H being formed in the piece plate stack J.

FIG. 13 is a partially-enlarged sectional view showing a state in which the piece plate stack J incorporated into the piece plate stack arrangement recess 9 of the split mold B₁ (B₂) is fixed with fixing bolts 31.

### DETAILED DESCRIPTION OF THE EMBODIMENTS

Hereinafter, the present invention will be described in more detail with reference to the best mode. A general configuration of an injection molding mold K for carrying out the present invention will be described first, and thereafter, a piece plate stack J configured such that a plurality of degassing piece plates P₁ to P₄ for forming degassing holes H is stacked on each other and a structure for incorporating the piece plate stack J into piece plate stack arrangement recesses 9 of split molds B₁, B₂, which are features of the present invention, will be described.

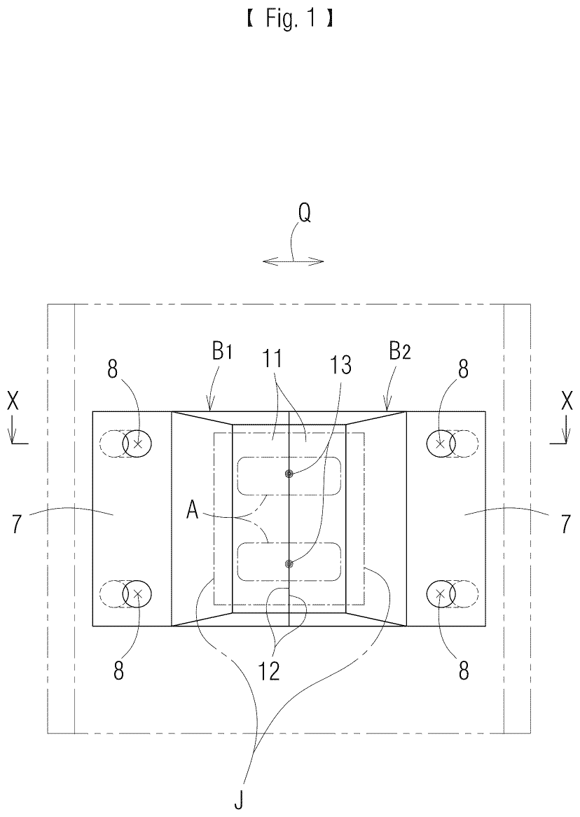

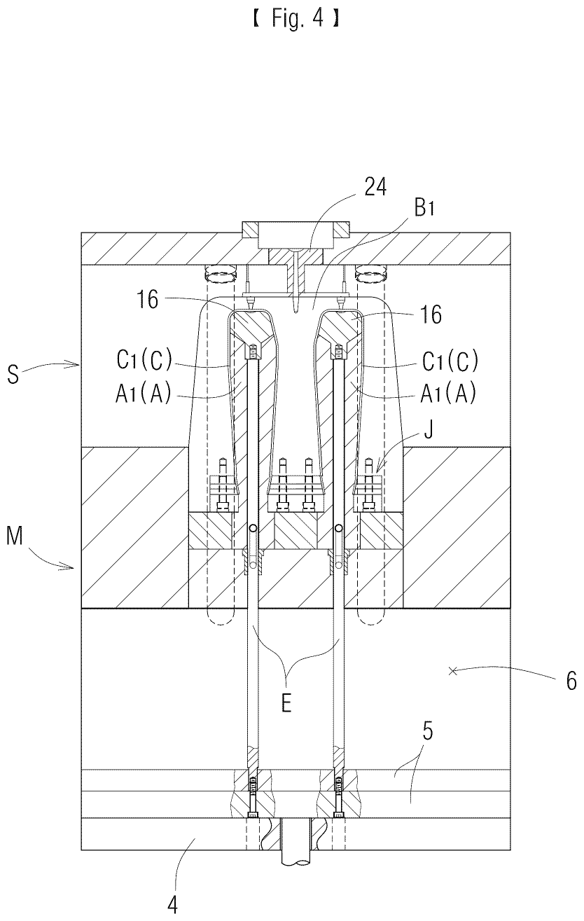

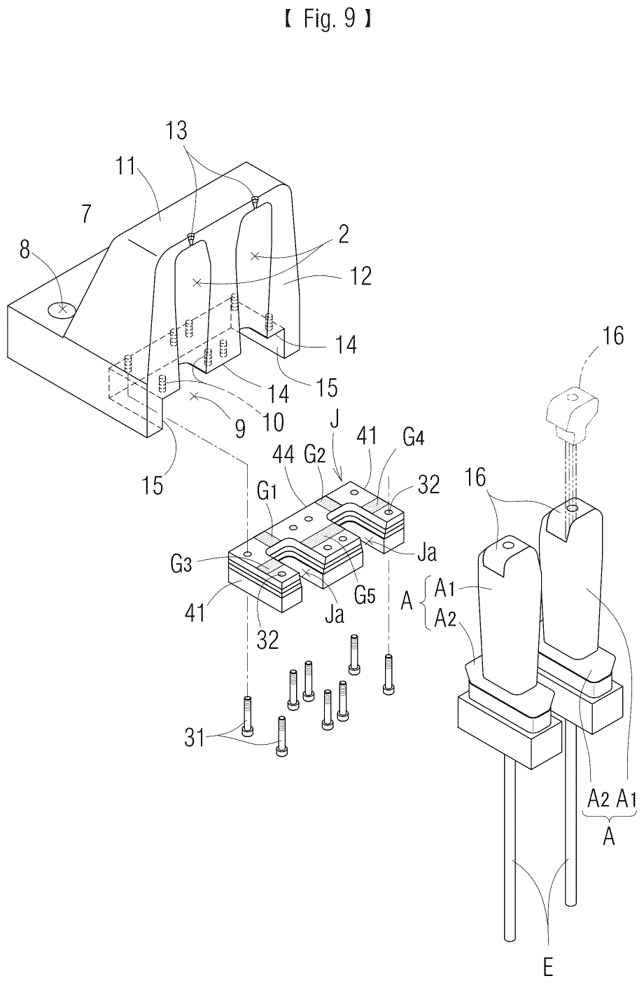

The injection molding mold K includes a fixed mold S and a movable mold M. As shown in FIGS. 1 to 6, the movable mold M is of a “double-cavity” type capable of simultaneously molding two molded articles, and has a rigid structure in a quadrangular shape in front view. At a center portion of a front portion of a vertically-disposed base 1 in the lateral direction thereof, a pair of core molds A is formed integrally with and perpendicularly to the base 1 at a predetermined interval in the up-down direction, and therefore, is disposed horizontally in an absolute space. The core mold A includes a columnar core body portion A₁ for molding a tubular portion F₁ of a molded article F having an irregular tubular shape, and a rectangular parallelepiped portion A₂ provided integrally with the base end of the core body portion A₁ for molding a rectangular box portion F₂ of the molded article F (see FIG. 9). The pair of left and right split molds B₁, B₂ is disposed so as to slide in the horizontal direction indicated by an arrow Q to approach and separate from each other on both sides of the pair of core molds A provided integrally with the center portion of the base 1 in the lateral direction thereof, and in a state of mold contact surfaces 12 closely contacting each other by closing the pair of split molds B₁, B₂, the inner peripheral surfaces of two molding recesses 2 formed in the mold contact surfaces 12 of mold bodies 11 of the pair of split molds B₁, B₂ and the outer peripheral surfaces of the two core molds A (pair of core molds A) provided integrally with the base 1 form a cavity C for molding the molded article F. The cavity C includes a hollow columnar first cavity C₁ formed between the core body portions A₁ of the core molds A and the pair of split molds B₁, B₂, and a box-shaped second cavity C₂ formed between the rectangular parallelepiped portions A₂ of the core molds A and the piece plate stacks J incorporated into the pair of split molds B₁, B₂.

A back plate 4 is disposed in back of the base 1 through a plurality of horizontal support rods 3, and a space formed by the back surface of the base 1, the back plate 4, and the left and right horizontal support rods 3 is a plate arrangement space 6 in which an ejector plate 5 is disposed. A back end portion of an ejector pin E for removing the molded articles F from the core molds A after injection molding is integrally coupled to the ejector plate 5.

In the movable mold M, the pair of split molds B₁, B₂ supported by the base 1 slides between a close end position (combined position) and a separate end position so as to approach and separate from each other. A mold body 21 of the fixed mold S is formed with a hollow truncated pyramid shaped mold fitting recess 22 to be fitted onto the outside of the truncated pyramid shaped mold bodies 11 of the pair of split molds B₁, B₂ combined at the close end position thereof, the mold fitting recess 22 being opened so as to face the movable mold M. In portions of the mold body 21 on both sides of the mold fitting recess 22 in plan view, four inclined angular pins 23, which are provided in two pairs, are provided in total so as to protrude to the movable mold M. The two inclined angular pins 23 of each pair are disposed in the same horizontal plane. About the half of the entire length of these inclined angular pins 23 is embedded in the mold body 21 of the fixed mold S, and the inclined angular pins 23 greatly laterally protrude with inclined such that an interval therebetween expands from the base end to the tip end. The two pairs of inclined angular pins 23 of the fixed mold S have a structure of being inserted into two pairs of inclined guide holes 8 formed so as to penetrate thick flange portions 7 of outer peripheral portions of the pair of split molds B₁, B₂.

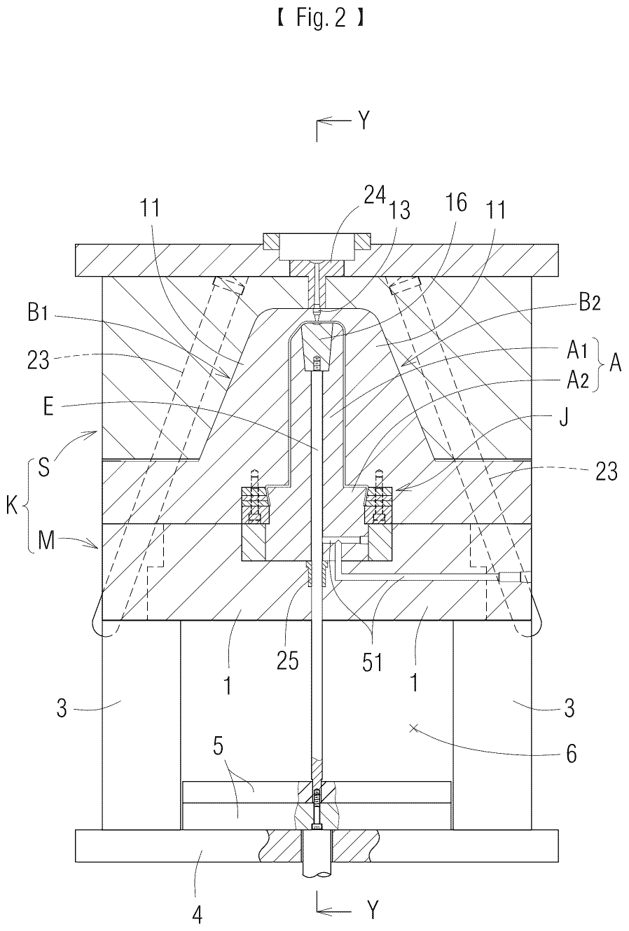

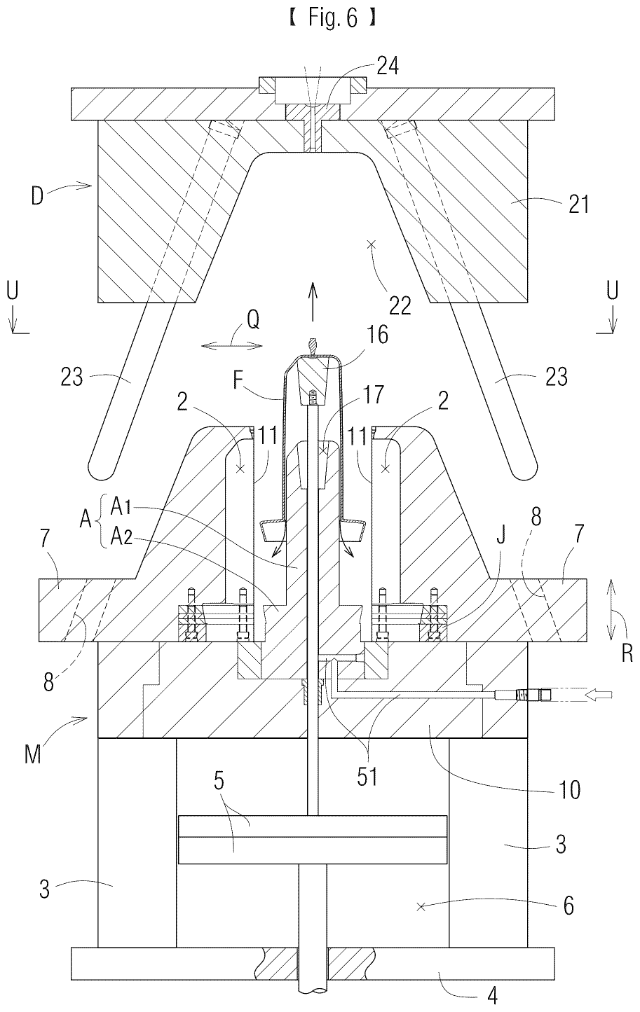

Thus, as shown in FIGS. 2 and 6, when the entirety of the movable mold M slides in the horizontal direction indicated by an arrow R relative to the fixed mold S in a state of the two pairs of inclined angular pins 23 of the fixed mold S being inserted into the inclined guide holes 8 of the pair of split molds B₁, B₂, the movable mold M separates from or approaches the fixed mold S. A sprue bush 24 for injecting molten thermoplastic elastomer (molten resin) is embedded in the fixed mold S. Note that for ensuring a space for removing the molded article F, the movable mold M is detached from the fixed mold S in such a manner that the two pairs of inclined angular pins 23 of the fixed mold S are fully detached from the inclined guide holes 8 formed in the thick flange portions 7 of the split molds B₁, B₂ to separate the pair of split molds B₁, B₂ from each other, as shown in FIG. 6.

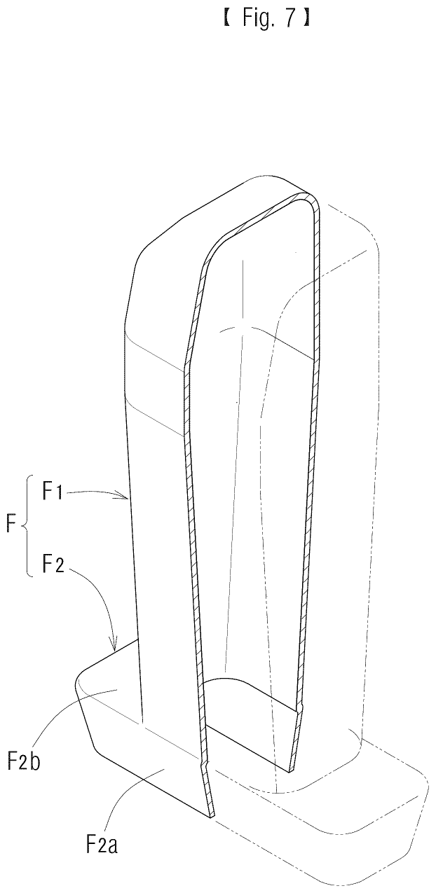

As shown in FIG. 7, the molded article F has such an irregular tubular shape that the tubular portion F₁ closed at one end is opened at the other end and such an opening has a greater dimension in a direction of the pair of split molds B₁, B₂ separating from each other in the rectangular box portion F₂ than in the tubular portion F₁. A portion of the cavity C forming the rectangular box portion F₂ is a portion to which the molten resin reaches last, and at two points in total, is bent at a right angle to a straight cavity portion for molding the tubular portion F₁. Thus, in such a portion, gas in the cavity tends to be collected and accumulated. Note that a peripheral wall portion F₂ₐ forming the rectangular box portion F₂ is slightly bent from a top wall portion F_{2b}, and the peripheral wall portion F₂ₐ and the top wall portion F_{2b} form an acute angle close to a right angle. Thus, in the present invention, as shown in FIGS. 9 to 12, in order to form many degassing holes H in portions of the pair of split molds B₁, B₂ of the movable mold M for molding the rectangular box portion F₂, the following structure is employed: the piece plate stack arrangement recess 9 in which the piece plate stack J configured such that the plurality (four in the present embodiment) of degassing piece plates P₁ to P₄ different from each other in a plate thickness and slightly different from each other in an entire shape are stacked on each other is disposed is formed in the portion of each split mold B₁, B₂ for molding the rectangular box portion F₂, and the piece plate stacks J are integrated with the split molds B₁, B₂ with a plurality of fixing bolts 31 in a state of being fitted in the piece plate stack arrangement recesses 9 to provide, inside the piece plate stacks J, many degassing holes H communicating with the outside of the split molds B₁, B₂. With this structure, gas in the portion of the cavity C for molding the rectangular box portion F₂ of the molded article F is discharged to the outside of the mold.

As shown in FIGS. 1 and 2, the truncated pyramid shaped combined portion of the mold bodies 11 of the pair of split molds B₁, B₂ closest to each other is fitted in the mold fitting recess 22 of the fixed mold S, and in this manner, the space formed by the outer peripheral surfaces of the core molds A and the inner peripheral surfaces of the molding recesses 2 formed in the mold contact surfaces 12 of the split molds B₁, B₂ is formed as the cavity (molding space) C. Opposing U-shaped recesses Ja (see FIG. 9) of the pair of piece plate stacks J fitted in the split molds B₁, B₂ are combined, the inner peripheral surfaces of the combined opposing U-shaped recesses Ja and the outer peripheral surfaces of the rectangular parallelepiped portions A₂ of the core molds A form the box-shaped second cavity C₂ of the cavity C for molding the rectangular box portion F₂ of the molded article F, and the second cavity C₂ and the outside of the split molds B₁, B₂ communicate with each other through many degassing holes H formed inside the piece plate stacks J. Note that in a state of the cavity C being formed, a short runner 13 communicating with the first cavity C₁ is formed as a result of the close contact between the mold contact surfaces 12 of the split molds B₁, B₂.

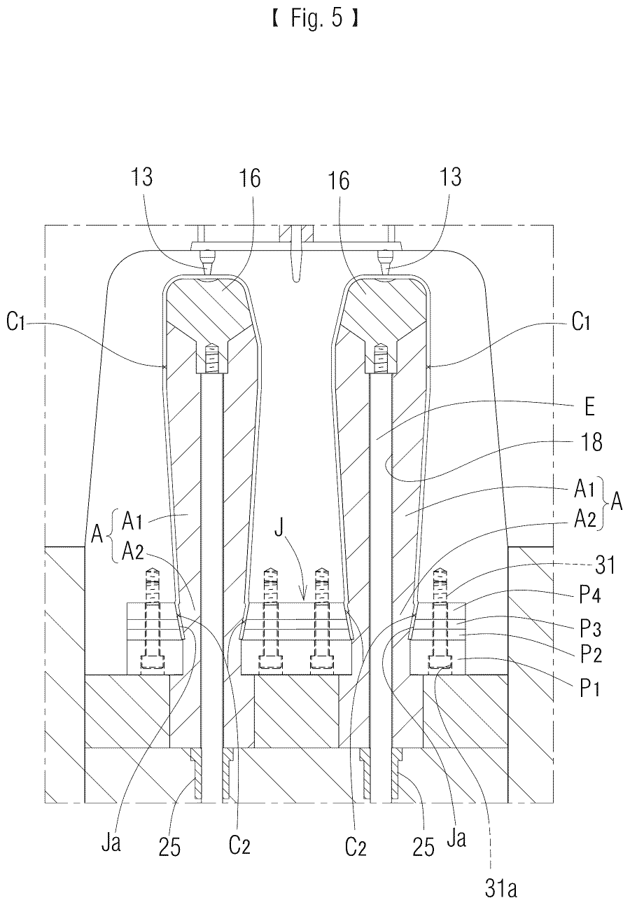

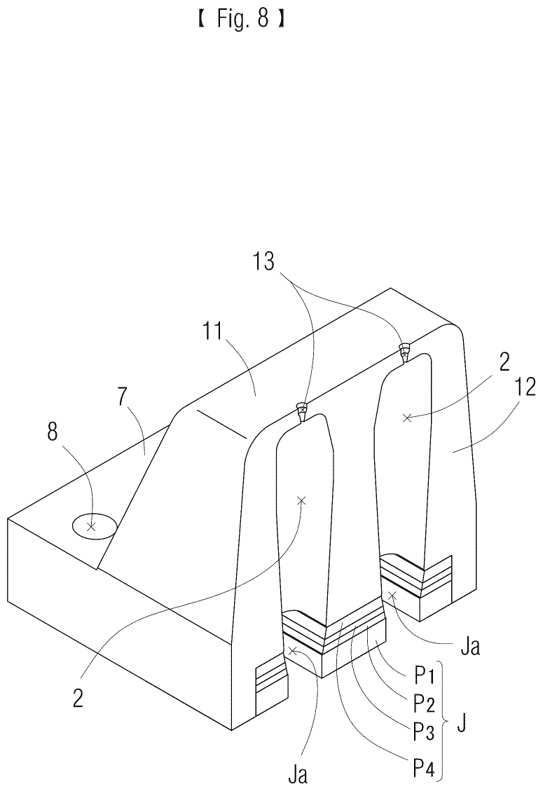

Next, the piece plate stack J will be described in more detail with reference to FIGS. 8 to 12. The piece plate stack J is fitted in the piece plate stack arrangement recess 9 of each split mold B₁, B₂, and is integrated with such a split mold B₁, B₂ with the plurality of fixing bolts 31. Since the injection molding mold K of the present embodiment is of the “double-cavity” type, two U-shaped recesses Ja are formed in one piece plate stack J, and these U-shaped recesses Ja are each disposed in the portions, which correspond to the rectangular box portions F₂ of the molded articles F, of the two cavities C formed by the pair of split molds B₁, B₂. Note that in FIGS. 5, 8, and 9, 33 indicates a built-in block having a planar shape identical to that of the piece plate stack J and disposed in a lower portion of each of the piece plate stacks J in the pair of split molds B₁, B₂. Note that in FIGS. 9 and 11, 10 indicates an internal thread portion formed in a top surface 14 of each split mold B₁, B₂ in the piece plate stack arrangement recess 9 to screw the fixing bolt 31 thereinto.

The piece plate stack J is formed in such a manner that the plurality (four in the present embodiment) of metal degassing piece plates P₁ to P₄ [in terms of a plate thickness, in a relationship of (P₁>P₂=P₃>P₄)] different from each other in a plate thickness and slightly different from each other only in the shape of a portion forming the second cavity C₂ for molding the rectangular box portion F₂ of the molded article F is stacked on each other. That is, the peripheral wall portion F₂ₐ forming the rectangular box portion F₂ of the molded article F is bent inward slightly at an acute angle to the top wall portion F_{2b}, and therefore, the plurality of degassing piece plates P₁ to P₄ forming the piece plate stack J is formed such that the width dimension of the U-shaped recess Ja of the piece plate stack J gradually increases from the lower side to the upper side and the end surfaces (continuous inner surfaces of the U-shaped recesses Ja) thereof form a continuous inclined surface.

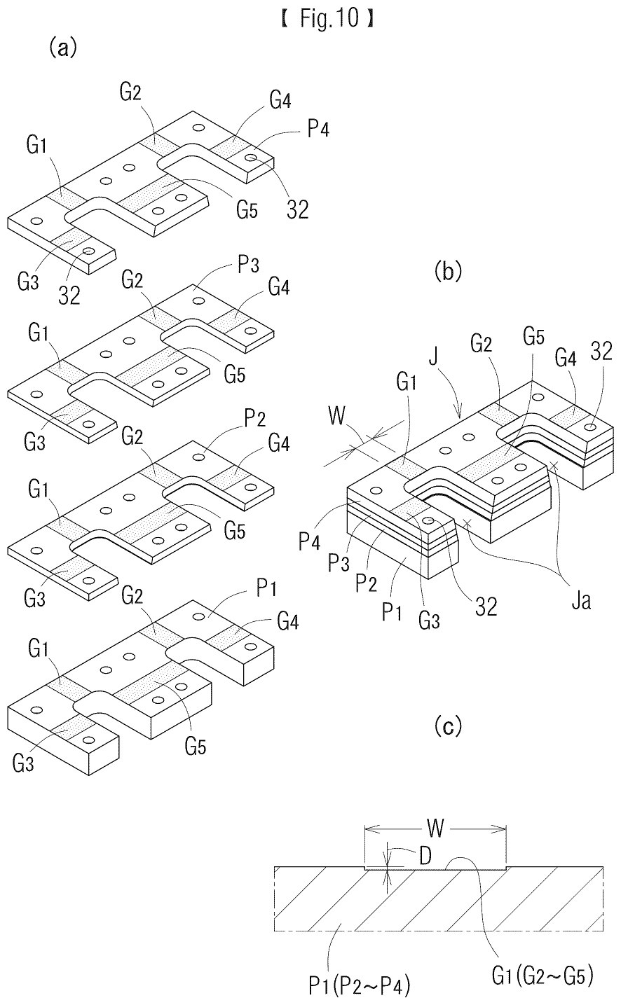

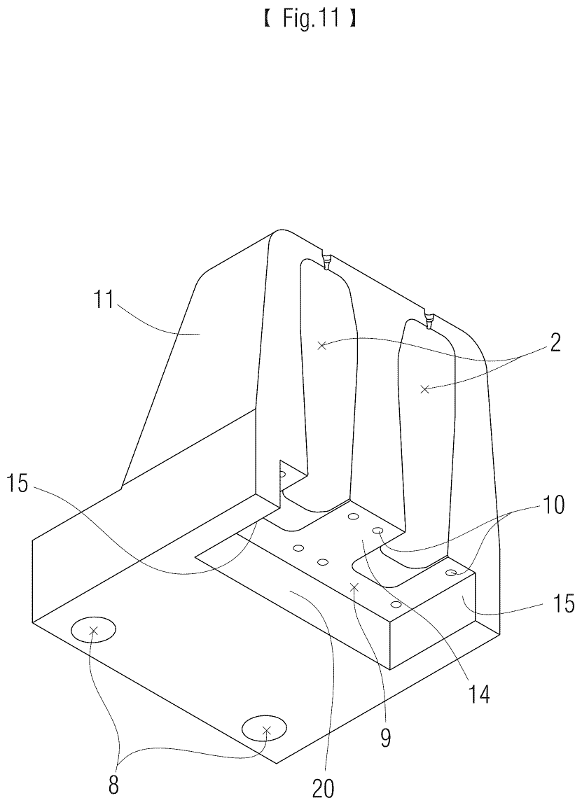

The entire shape of each degassing piece plate P₁ to P₄ is a rectangular shape as shown in FIGS. 10(a) to 10(c), and such a degassing piece plate P₁ to P₄ is formed in one surface (upper surface in the stacked state) with a plurality of extremely-shallow degassing grooves G₁ to G₅ over the entire width of such a portion. That is, the degassing grooves G₁, G₂ are formed perpendicularly to the remaining long side of the degassing piece plate P₁ to P₄ having the rectangular shape as a whole over the entire length between such a long side and the U-shaped recesses Ja, the degassing grooves G₃, G₄ are formed in center portions of remaining rectangular portions in the longitudinal direction thereof outside the U-shaped recesses Ja over the entire length in the width direction (the longitudinal direction of the degassing piece plate P₁ to P₄ when such a plate is viewed as a whole) of these rectangular portions, and the degassing groove G₅ is formed in a remaining substantially square portion between the U-shaped recesses Ja over the entire length on the extension of the degassing grooves G₃, G₄. The degassing grooves G₁ to G₅ are stacked on each other, and therefore, the degassing grooves G₁ to G₅ and another degassing piece plate P₂ to P₄ stacked above these degassing grooves G₁ to G₅ so as to cover these degassing grooves G₁ to G₅ or the top surface 14 (see FIG. 11) of the split mold B₁, B₂, which closely contacts the uppermost degassing piece plate P₄, in the piece plate stack arrangement recess 9 form many degassing holes H inside the piece plate stack J. The depth D [see FIG. 10(c)] of the degassing groove G₁ to G₅ formed in each degassing piece plate P₁ to P₄ is 0.02 to 0.03 mm, and is such a dimension that no molten resin enters due to an injection pressure when the molten resin is injected and molded in the cavity C. Each extremely-shallow degassing groove G₁ to G₅ is formed in such a manner that a specified position of each metal degassing piece plate P₁ to P₄ is ground with a grinding machine. Although the degassing groove G₁ to G₅ can also be formed by etching for dissolving the surface of the metal plate, the grinding with the grinding machine is a preferred formation method because each degassing groove G₁ to G₅ has a simple quadrangular shape having the same width over the entire length. Note that in FIG. 9 and FIGS. 10(a) to 10(c), the degassing grooves G₁ to G₅ cannot be three-dimensionally shown because these grooves are extremely shallow, and for this reason, are “shown with dots”.

A portion of each degassing piece plate P₁ to P₄ apart from the degassing grooves G₁, G₂ is formed with a plurality of bolt insertion holes 32 into which many fixing bolts 31 for fixing the piece plate stack J, which is configured such that the degassing piece plates P₁ to Pa are stacked on each other, to the top surface 14 of the split mold B₁, B₂ in the piece plate stack arrangement recess 9 are inserted in a state of the piece plate stack J being incorporated into the piece plate stack arrangement recess 9 of the split mold B₁, B₂. In the degassing piece plate P₁ disposed on the lowermost side and having the greatest plate thickness, head portion insertion holes 32a in which the entireties of head portions 31a of the headed fixing bolts 31 can be inserted and disposed are connected to the bolt insertion holes 32.

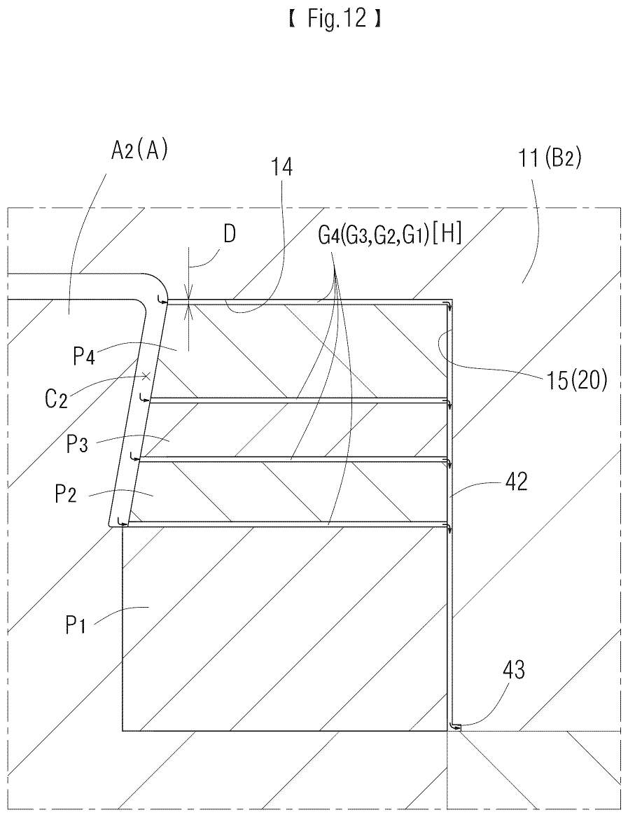

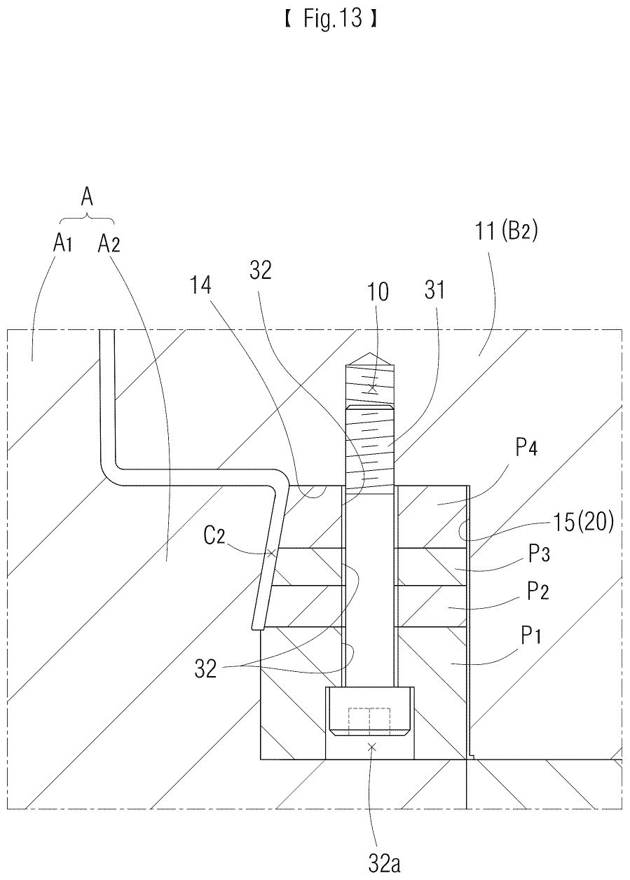

Thus, when the piece plate stack J is incorporated into the piece plate stack arrangement recess 9 of the split mold B₁, B₂ and is integrated with the split mold B₁, B₂ with many fixing bolts 31, the sectional view of such a piece plate stack J is as shown in FIG. 13. Note that the depth D of the degassing groove G₄ is extremely shallow and cannot be shown in the figure, and for this reason, FIG. 12 shows the depth D of the degassing groove G₄ much deeper than the actual depth regardless of the ratio between the depth D of the degassing groove G₄ and the plate thickness of the degassing piece plate P₁ to P₄. In the piece plate stack J integrally incorporated into the piece plate stack arrangement recess 9 of the split mold B₁, B₂, the upper surfaces of the degassing grooves G₁ to G₅ are closed to form many degassing holes H, and at the end of each degassing hole H opposite to the end communicating with the second cavity C₂, a gas discharge gap 42 is formed between a first outer end surface 41 of the piece plate stack J and the inner surface 15 (see FIGS. 9 and 11) of the split mold B₁, B₂ facing the piece plate stack arrangement recess 9, and the gas discharge gap 42 is further formed with an external communication hole 43 communicating with the outside of the split mold B₁, B₂. The sectional view of the degassing hole H formed by the degassing groove G₃ inside the piece plate stack J is a view horizontally inverted from FIG. 12. Further, for the degassing holes H formed by the degassing grooves G₁, G₂ inside the piece plate stack J, another gas discharge gap 42 similar to the above-described gas discharge gap 42 is formed between a second outer end surface 44 of the piece plate stack J and a far-side inner surface 20 (see FIG. 11) perpendicular to both the inner surfaces 15 of the split mold B₁, B₂ facing the piece plate stack arrangement recess 9, and gas in the cavity C is discharged to the outside of the split mold B₁, B₂. In the present embodiment, the piece plate stack J incorporated into one split mold B₂ is formed with (4×4=16 degassing holes H), and another piece plate stack J incorporated into the other split mold B₁ is also formed with the same number of holes. Thus, the total number of degassing holes H formed inside the piece plate stacks J is 32 in the portion of the cavity C for molding the rectangular box portion F₂. In addition, many degassing holes H are substantially equally disposed along both the circumferential direction and height direction of the portion of the second cavity C₂ for molding the peripheral wall portion F₂ₐ of the rectangular box portion F₂ of the molded article F, and therefore, the sealed gas is effectively discharged to the outside without being accumulated. Note that the degassing groove G₅ causes the second cavities C₂ of each “double-cavity” type split mold B₁, B₂ to communicate with each other, and therefore, does not serve as a “degassing hole”, but serves as a “gas communication hole”. Thus, for example, in a case where there is a pressure difference between these cavities, gas can move from one cavity to the other cavity such that a gas accumulation state is equalized between the cavities, and therefore, the gas in each cavity can be effectively discharged.

Thus, the molten resin reaches last the portion for molding the rectangular box portion F₂ of the molded article F when the molten resin is injected into the cavity C, and in addition, reaches such a portion together with gas. Thus, the gas tends to be accumulated, but is reliably discharged to the outside of the split mold B₁, B₂ through many degassing holes H formed in the piece plate stack J, the gas discharge gap 42, and the external communication hole 43. Thus, a sink mark, underfill, and the like at the rectangular box portion F₂ of the molded article F, particularly the outer surface thereof, as in a conventional molding method can be reduced, and the molding can be performed with a high yield rate.

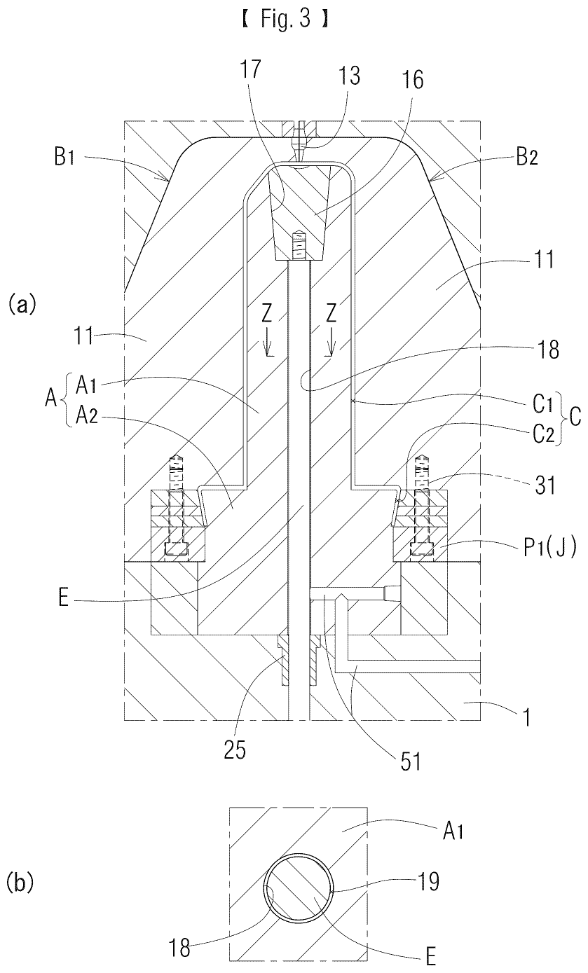

As shown in FIGS. 3, 5, and 9, a tip end portion of the core body portion A₁ of each core mold A is formed with a wide block fitting groove 17 in which an ejector block 16 integrally coupled to a tip end portion of the ejector pin E is fitted, and an ejector pin hole 18 into which the ejector pin E is inserted is formed so as to penetrate such a core mold A. A portion of the ejector pin E inserted into the core mold A is formed with a smaller diameter than those of other portions, and therefore, a compressed air circulation gap 19 is formed between such a portion and the inner peripheral surface of the ejector pin hole 18 [see FIG. 3(b)].

In a state in which the ejector block 16 coupled to the tip end portion of the ejector pin E is fitted in the block fitting groove 17 in the tip end portion of the core body portion A₁ of the core mold A, such an ejector block 16 forms the tip end portion of the core body portion A₁ of the core mold A. That is, as shown in FIG. 6, the width of the block fitting groove 17 is gradually increased from the portion coupled to the ejector pin hole 18 to the tip end. When the ejector block 16 protrudes from the block fitting groove 17 due to protrusion of the ejector pin E, compressed air supplied to the compressed air circulation gap 19 is injected between the inner peripheral surface of the molded article F and the outer peripheral surface of the core mold A through an air circulation gap (not shown) formed between the inner surface of the block fitting groove 17 and the outer surface of the ejector block 16, and accordingly, the molded article F is slightly expanded. Thus, the inner peripheral surface of the molded article F is slightly separated from the outer peripheral surface of the core mold A, and by protruding the ejector pin E in this state, the molded article F is removed from the core mold A. In FIGS. 2 and 3, 51 indicates a compressed air hole formed between the base 1 and one split mold B₂ of the movable mold M and communicating with the compressed air circulation gap 19. Note that in FIGS. 2, 3, and 5, 25 indicates a bush incorporated into the base 1 of the movable mold M to close the lower end side of the compressed air circulation gap 19 by inserting part of the ejector pin E into the bush.

There are various shapes of the rectangular box portion (great-dimension portion) F₂ of the actual molded article F under the condition that the entirety thereof is in the quadrangular shape, and various entire shapes of the degassing piece plate and various numbers of degassing piece plates stacked are set depending on the shape of the great-dimension portion.

In order to increase the total number of degassing holes H formed in the piece plate stack J, the degassing grooves can be formed in both the front and back surfaces of the degassing piece plate.

In the above-described embodiment, the example where the present invention is applied to the “double-cavity” type injection molding mold has been described, but needless to say, the present invention can also be applied to a “multi-cavity” type injection molding mold with two or more cavities and a “single-cavity” type injection molding mold by changing the entire shape of the degassing piece plate.

Further, in the above-describe embodiment, the injection molding mold has been described, which is for molding the irregular tubular molded article opened only on one end side in the removal direction, closed on the other end side which is the molten resin injection side, and having, on the opening side, the quadrangular box-shaped great-dimension portion having a greater dimension than those of other portions. However, the present invention can also be applied to an injection molding mold for molding an irregular tubular molded article opened only on one end side in a removal direction, closed on the other end side which is a molten resin injection side, and having no great-dimension portion on the opening side.

### REFERENCE SIGNS LIST

A: Core mold
   A₁: Core body portion
   A₂: Rectangular parallelepiped portion of core mold
B₁, B₂: Split mold
C: Cavity
   C₁: First cavity
   C₂: Second cavity
D: Depth of degassing groove
F: Molded article
   F₁: Tubular portion
   F₂: Rectangular box portion (great-dimension portion)
      F₂ₐ: Peripheral wall portion of rectangular box portion
      F_{2b}: Top wall portion of rectangular box portion
G₁ to G₅: Degassing groove
H: Degassing hole
J: Piece plate stack
   Ja: U-shaped recess of piece plate stack
K: Injection molding mold
M: Movable mold
P₁ to P₄: Degassing piece plate
Q: Split mold sliding direction
R: Movable mold sliding direction
W: Width of degassing groove
9: Piece plate stack arrangement recess
31: Fixing bolt
32: Bolt insertion hole
   32a: Head portion insertion hole

1. An injection molding mold comprising:
a columnar core mold; and
a pair of split molds disposed so as to surround the core mold to form a cavity,
wherein molten resin is injected into the cavity to mold an irregular tubular molded article opened only at one end portion in a removal direction, closed at the other end portion on a molten resin injection side, and at an opened portion, provided with a quadrangular box-shaped great-dimension portion having a greater dimension than those of other portions, and thereafter, the split molds are separated from the core mold and the molded article is removed from the core mold,
a piece plate stack configured such that a plurality of flat plate-shaped degassing piece plates, each of which is formed with a degassing groove at least in one surface, is stacked and integrated along the molded article removal direction is incorporated into a piece plate stack arrangement recess provided in a portion of each split mold for molding the great-dimension portion, and the degassing grooves form, in the portion of each split mold for molding the great-dimension portion of the molded article, many degassing holes causing a portion of the cavity for molding the great-dimension portion and an outside of the molding mold to communicate with each other, and
each degassing groove forming the degassing holes is formed with such a depth that entrance of the molten resin injected into the cavity into the degassing holes is able to be reduced.

2. The injection molding mold according to claim 1, wherein
a depth of the degassing groove is 0.02 to 0.03 mm.

3. The injection molding mold according to claim 1, wherein
among the plurality of degassing piece plates, a degassing piece plate disposed on an outermost side has a greatest plate thickness, and a middle degassing piece plate has a smaller plate thickness than that of a degassing piece plate disposed on each side of the middle degassing piece plate in a stacking direction, and the piece plate stack incorporated into the piece plate stack arrangement recess of each split mold is fixed to the each split mold with a plurality of fixing bolts.

4. The injection molding mold according to claim 1, wherein
a gas discharge gap through which gas is discharged to the outside of the molding mold through the many degassing holes formed inside the piece plate stack is formed between an outer surface, which is opposite to the cavity, of the piece plate stack incorporated into the piece plate stack arrangement recess and an inner surface of the piece plate stack arrangement recess.

5. The injection molding mold according to claim 1, wherein
the injection molding mold has a configuration capable of simultaneously molding two molded articles, and cavities for molding the molded articles communicate with each other through another degassing hole formed inside the piece plate stack.

6. The injection molding mold according to claim 2, wherein
among the plurality of degassing piece plates, a degassing piece plate disposed on an outermost side has a greatest plate thickness, and a middle degassing piece plate has a smaller plate thickness than that of a degassing piece plate disposed on each side of the middle degassing piece plate in a stacking direction, and the piece plate stack incorporated into the piece plate stack arrangement recess of each split mold is fixed to the each split mold with a plurality of fixing bolts.

7. The injection molding mold according to claim 2, wherein
a gas discharge gap through which gas is discharged to the outside of the molding mold through the many degassing holes formed inside the piece plate stack is formed between an outer surface, which is opposite to the cavity, of the piece plate stack incorporated into the piece plate stack arrangement recess and an inner surface of the piece plate stack arrangement recess.

8. The injection molding mold according to claim 2, wherein
the injection molding mold has a configuration capable of simultaneously molding two molded articles, and cavities for molding the molded articles communicate with each other through another degassing hole formed inside the piece plate stack.

9. An injection molding mold comprising:
a columnar core mold; and
a pair of split molds disposed so as to surround the core mold to form a cavity,
wherein molten resin is injected into the cavity to mold an irregular tubular molded article opened only at one end portion in a removal direction and closed at the other end portion on a molten resin injection side, and thereafter, the split molds are separated from the core mold and the molded article is removed from the core mold,
a piece plate stack configured such that a plurality of flat plate-shaped degassing piece plates, each of which is formed with a degassing groove at least in one surface, is stacked and integrated along the molded article removal direction is incorporated into a piece plate stack arrangement recess provided in a portion of each split mold for molding an opening side of the molded article, and the degassing grooves form, in the portion of each split mold for molding the opening side of the molded article, many degassing holes causing a portion of the cavity for molding the opening side of the molded article and an outside of the molding mold to communicate with each other, and
each degassing groove forming the degassing holes is formed with such a depth that entrance of the molten resin injected into the cavity into the degassing holes is able to be reduced.
